(19) United States
(12) Patent Application Publication
(10) Pub. No.: US 2013/0320101 A1
(43) Pub. Date: Dec. 5, 2013

(54) WATER VALVE ASSEMBLY

(71) Applicant: Tsai-Chen YANG, Taichung City (TW)

(72) Inventor: Tsai-Chen YANG, Taichung City (TW)

(21) Appl. No.: 13/483,580

(22) Filed: May 30, 2012

(51) Int. Cl. G05D 23/13

(52) U.S. Cl. 236/12.11

(57) ABSTRACT

A water valve assembly of the present invention includes a temperature controller, a main controller, and a connecting tube disposed therebetween. Water entering the temperature controller further enters the main controller via the connecting tube and is discharged from the main controller. The temperature controller and the main controller are arranged in an edge of bathtub, and the connecting tube is parallel to the edge of bathtub. Also, water always flows not parallely to a width of the edge of bathtub in the water valve assembly. Thus, the water valve assembly of the present invention is able to be installed in a narrower edge of bathtub.

### BACKGROUND OF THE INVENTION

1. Field of the Invention

The present invention relates to a temperature-controlling water valve, more specifically to one which is able to be installed in a narrower edge of bathtub.

2. Description of the Prior Art

A conventional water faucet in bathroom usually has a faucet and a handle which are arranged in a cross manner, as disclosed in patent TW 586598. However, the inlet pipes are usually exposed to result risk of burning by touching accidentally. In addition, larger room is needed due to the cross arrangement. Also, the cross arrangement is hard to be installed on an edge of bathtub and has to be installed inside the wall. Thus, difficulty of installation is promoted.

On the other hand, a conventional faucet is unable to maintain outflowing water at a predetermined temperature. When temperature of original water is changed by weather or other factors, temperature of outflowing water may be changed too. Thus, a user should adjust the ratio of amount of cold water and hot water every time, and time and water resource are wasted. Furthermore, if temperature of original hot water is not static, the outflowing water is unable to be maintained at a static temperature. However, most conventional thermo-static adjustment devices should be installed on water heaters, so a user can not adjust the temperature of water simultaneously when using.

The present invention is, therefore, arisen to obviate or at least mitigate the above mentioned disadvantages.

### SUMMARY OF THE INVENTION

The main object of the present invention is to provide a water valve assembly which is adapted for a narrower edge of bathtub.

To achieve the above and other objects, a water valve assembly of the present invention includes a temperature controller, a main controller, and a connecting tube.

The temperature controller has a first valve body, a cold water inlet, a hot water inlet, and a first outlet. The first valve body is able to adjust ratio of amount of water entering the temperature controller via the cold water inlet and the hot water inlet. Water entering via the cold water inlet and the hot water inlet is mixed in the temperature controller and is discharged via the first outlet.

The main controller has a second valve body, a mixed water inlet, and a second outlet. Water discharged from the temperature controller enters the main controller through the connecting tube and the mixed water inlet. The second valve body is able to adjust amount of water entering the main controller via the second outlet.

A longitudinal direction is defined from the temperature controller and the main controller. The connecting tube extends paralelly to the longitudinal direction. Water enters the temperature controller via the cold water inlet and the hot water inlet along a height direction of the temperature controller upward, and mixed water in the temperature controller is discharged via the first outlet along the longitudinal direction. Water in the main controller is discharged via the second outlet along a height direction of the main controller downward. The height direction of the temperature controller and the height direction of the main controller are parallel to each other but both perpendicular to the longitudinal direction.

Besides, an outer diameter of the connecting tube is equal to or smaller than each of a diameter of the first outlet and a diameter of the mixed water inlet. Thus, two opposite ends of the connecting tube are inserted in the first outlet and the mixed water inlet respectively. An o-ring is sleeved onto each end of the connecting tube and is sandwiched between the connecting tube and one of the mixed water inlet and the first outlet. Two nuts are sleeved onto the connecting tube, and each nut covers one of the o-ring and is screwed to a periphery of one of the mixed water inlet or the first outlet. In addition, a blocking flange is formed on the connecting tube and is sandwiched between one of the o-rings and corresponding nut, so that the end having the blocking flange of the connecting tube is unable to extend inside of the first outlet or the mixed water inlet.

Thereby, the water valve assembly of the present invention is able to be installed in an edge of bathtub, wherein the temperature controller and the main controller are arranged spacedly along the edge of bathtub. Besides, directions of water flowing in and out are both not parallel to a width of bathtub. Thus, width of bathtub can be minimized.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of the present invention;

FIG. 2 is a breakdown drawing of the present invention;

FIG. 3 is a profile of the present invention;

FIG. 4 is an illustration of the present invention;

### DETAILED DESCRIPTION OF THE PREFERRED EMBODIMENTS

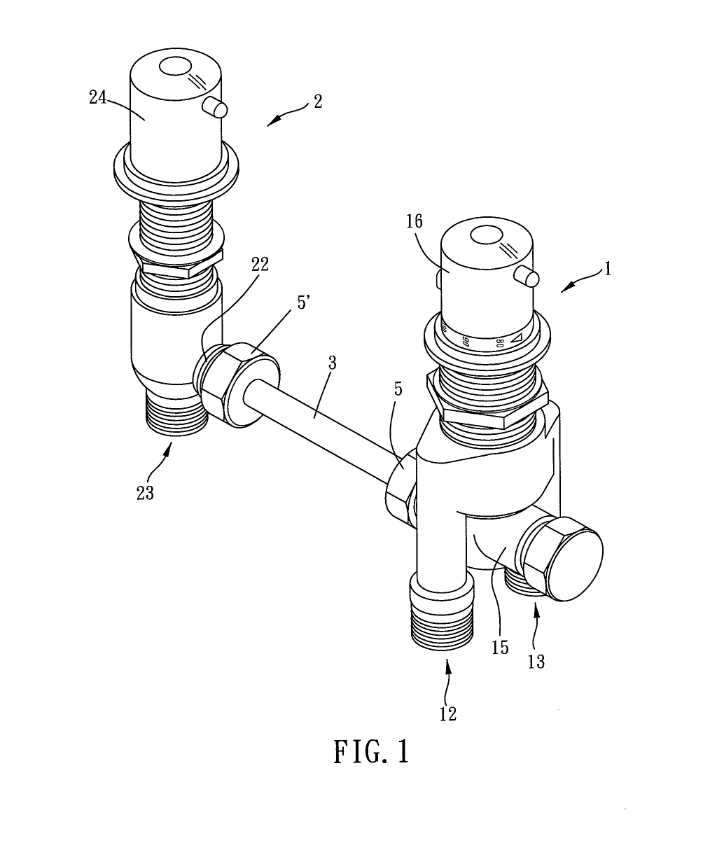

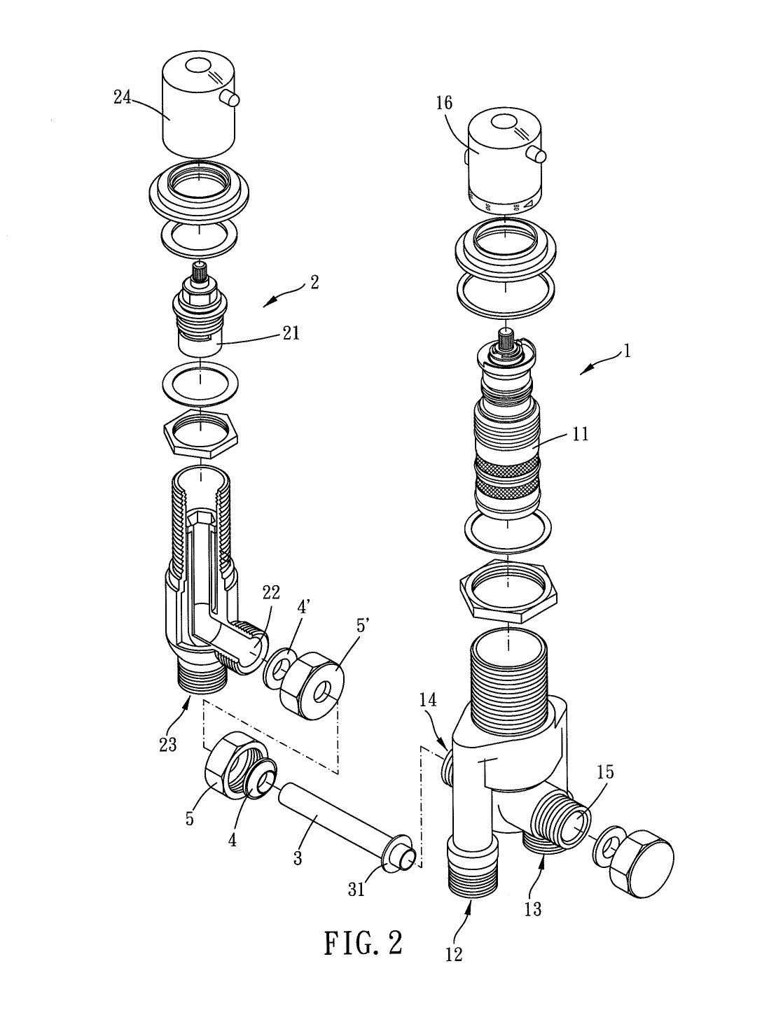

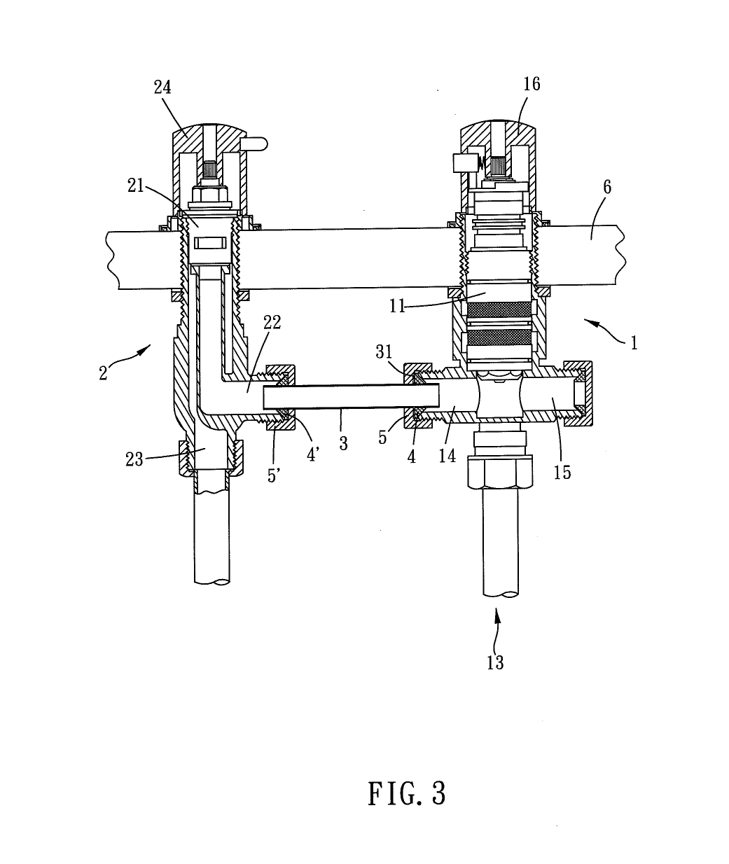

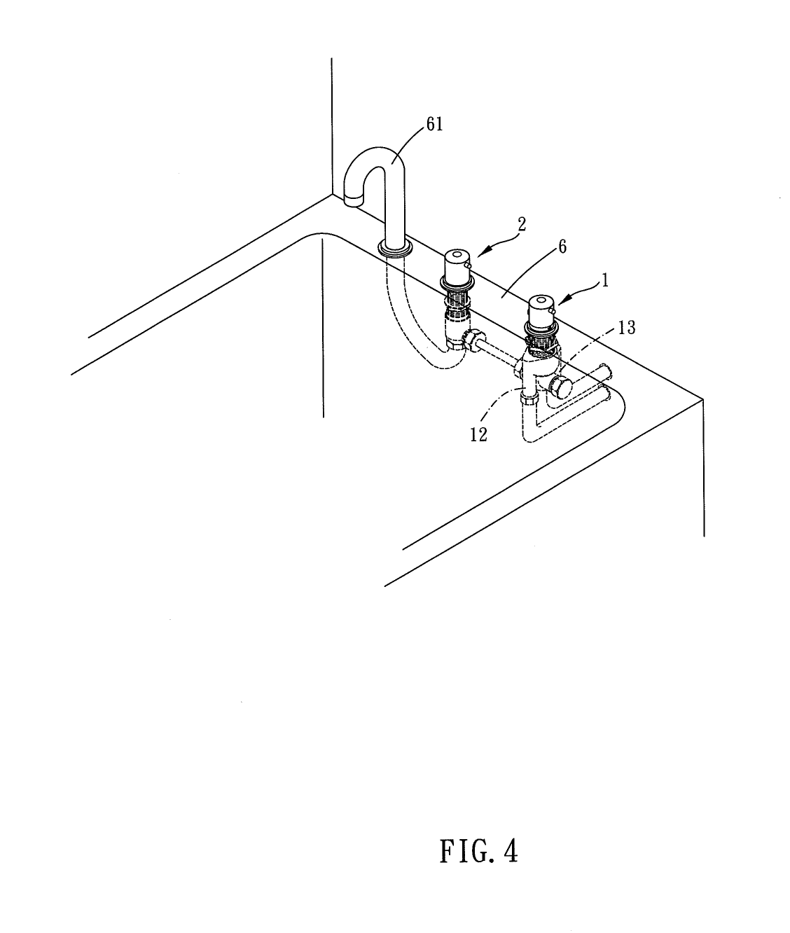

Please refer to FIG. 1 to FIG. 4, the water valve assembly of the present embodiment includes a temperature controller 1, a main controller 2, and a connecting tube 3 and is adapted for installed in a narrower edge of bathtub.

The temperature controller 1 includes a first valve body 11, a cold water inlet 12, a hot water inlet 13, and a first outlet 14. The first valve body 11 is able to adjust ratio of amount of water entering the temperature controller 1 via the cold water inlet 12 and the hot water inlet 13. More preferably, the first valve body 11 is able to detect temperature of mixed water in the temperature controller 1 and automatically adjust the ratio of water entering the temperature controller 1 via the cold water inlet 12 and the hot water inlet 13 to maintain the mixed water at a specific temperature. For example, a rod with high coefficient of thermal expansion is used widely in prior art. Expansion-contraction motion of the rod drives a mask to move, so that the ratio of areas blocked by the mask of the cold water inlet and the hot water inlet can be adjusted. Thus, ratio of amount of cold water and hot water is able to be adjusted automatically.

The temperature controller 1 further has a control portion 16 which is able to alter the specific temperature to accommodate water temperature to a user's need. Water entering the temperature controller 1 via the cold water inlet 12 and the hot water inlet 13 is mixed in the temperature controller 1 and is discharged via the first outlet 14. In other possible embodiment of the present invention, the temperature controller 1 further forms a third outlet 15 which is located on a side of the temperature controller 1 opposite to the first outlet 14. Water in the temperature controller is thereby discharged via the first outlet 14 and the third outlet 15.

The main controller 2 has a second valve body 21, a mixed water inlet 22, and a second outlet 23. The second valve body 21 is able to adjust amount of water discharged via the second outlet 23. More preferably, the main controller 2 has a adjusting portion 24 connected with the second valve body 21, and a user is able to manually adjust the amount of water discharged via the second outlet 23.

The connecting tube 3 is disposed between the first outlet 14 and the mixed water inlet 22 and communicates the first outlet 14 and the mixed water inlet 22. An outer diameter of the connecting tube 3 is equal to or smaller than a diameter of each of the first outlet 14 and the mixed water inlet 22, so that two opposite ends of the connecting tube 3 are able to be inserted into the first outlet 14 and the mixed water inlet 22. An o-ring 4,4′ is sleeved onto each end of the connecting tube 3 and is sandwiched between the connecting tube 3 and one of the first outlet 14 and the mixed water inlet 22. Two nuts 5,5′ are sleeved onto the connecting tube 3, and each nut 5,5′ covers one of the o-ring 4,4′ and then is screwed to a periphery of one of the first outlet 14 and the mixed water inlet 22. In addition, a blocking flange 31 is protrusively formed on the connecting tube 3 and is sandwiched between one of the o-ring 4′ and corresponding nut 5′, so that the end having the blocking flange 31 of the connecting tube 3 is unable to further insert into the first outlet 14 or the mixed water inlet 22. Besides, the blocking flange 31 is able to contribute to anti-leaking and fixation. On the contrary, the end without the blocking flange 31 of the connecting tube 3 is able to alternatively further insert into the first outlet 14 or the mixed water inlet 22 to alter distance between the temperature controller 1 and the main controller 2.

On the other hand, a longitudinal direction is defined from the temperature controller 1 to the main controller 2, and the connecting tube 3 extends parallely to the longitudinal direction. Water enters the temperature controller 1 via the cold water inlet 12 and the hot water inlet 13 along a height direction of the temperature controller 1 upward. The mixed water in the temperature controller 1 is discharged via the first outlet 14 or the third outlet 15 along the longitudinal direction. Water in the main controller 2 is discharged via the second outlet 23 along a height direction of the main controller 2 downward. The height direction of the temperature controller 1 and the height direction of the main controller 2 are parallel to each other but perpendicular to the longitudinal direction.

In conclusion, the temperature controller 1 and the main controller 2 are disposed in an edge 6 of bathtub, and water always flows not parallely to a width of the edge 6 of bathtub. Thus, the width of the edge of bathtub can be minimized, so that the water valve assembly of the present invention is much more room-saving. Besides, most part of the water valve assembly is embedded in the edge 6 of bathtub, and only the control portion 16, the adjusting portion 24, and a faucet connecting with the second outlet are exposed outside of the edge 6 of bathtub. Hence, the water valve assembly of the present invention is more room-saving and pleasing to the eye. Also, burning resulting by touching water inlet pipes accidentally is prevented.

What is claimed is:

1. A water valve assembly, comprising:
a temperature controller, having a first valve body, a cold water inlet, a hot water inlet, and a first outlet, the first valve boy being able to control ratio of amount of water entering the temperature controller from each of the cold water inlet and the hot water inlet, water entering the temperature controller from the cold water inlet and the hot water inlet being mixed in the temperature controller and then being discharged via the first outlet;
a main controller, having a second valve body, a mixed water inlet, and a second outlet, the second valve being able to adjust amount of water discharged via the second outlet;
a connecting tube, disposed between and communicating the first outlet and the mixed water inlet;
wherein a longitudinal direction is defined from the temperature controller to the main controller, the connecting tube extends parallelly to the longitudinal direction, water is able to enter the temperature controller via the cold water inlet and the hot water inlet along a height direction of the temperature controller upward, mixed water in the temperature controller is able to be discharged via the first outlet along the longitudinal direction, water in the main controller is able to be discharged via the second outlet along a height direction of the main controller downward, the height direction of the temperature controller and the height direction of the main controller are parallel to each other but perpendicular to the longitudinal direction.

2. The water valve assembly of claim 1, wherein an outer diameter of the connecting tube is equal to or smaller than a diameter of each of the first outlet and a diameter of the mixed water inlet, two opposite ends of the connecting tube are inserted in the first outlet and the mixed water inlet respectively, a o-ring is sleeved onto each end of the connecting tube to be sandwiched between the connecting tube and one of the first outlet or the mixed water inlet, two nuts are sleeved onto the connecting tube, each nut covers one of the o-ring and is screwed to a periphery of one of the mixed water inlet or the first outlet, a blocking flange is protrusively formed on the connecting tube, the blocking flange is sandwiched between one of the o-rings and corresponding nut to prevent the end with the blocking flange of the connecting tube from entering one of the first outlet or the mixed water inlet further.

3. The water valve assembly of claim 1, wherein the first valve body is able to detect temperature of mixed water in the temperature controller and to automatically adjust ratio of water entering the temperature controller via the cold water inlet and the hot water inlet to maintain a specific temperature of mixed water in the temperature controller.

4. The water valve assembly of claim 3, wherein the temperature controller has a control portion, the control portion is able to adjust the specific temperature.

5. The water valve assembly of claim 1, wherein the temperature controller further has a third outlet, the third outlet is formed at an opposite side of the temperature controller from the first outlet, the mixed water in the temperature controller is able to be discharged via the third outlet.
